(19) United States
(12) Patent Application Publication
(10) Pub. No.: US 2002/0001652 A1
(43) Pub. Date: Jan. 3, 2002

(54) Process for making granulated N-[N- (3, 3-dimethylbutyl) -L-alpha -aspartyl] -L- phenylalanine 1-methyl ester

(76) Inventor: Aditi Dron, Streamwood, IL (US)

Correspondence Address: FITZPATRICK CELLA HARPER & SCINTO, 30 ROCKEFELLER PLAZA, NEW YORK, NY, 10112, US

(21) Appl. No.: 09/784,970

(22) Filed: Feb. 16, 2001

Related U.S. Application Data
(60) Provisional application No. 60/182,908, filed on Feb. 16, 2000.

(51) Int. Cl. A23L 1/236

(52) U.S. Cl. 426/548; 426/285

(57) ABSTRACT

N-[N-(3,3-dimethylbutyl)-L-α-aspartyl]-L-phenylalanine 1-methyl ester is converted from a light powder to relatively dustless, free-flowing granules using compaction, preferably roller compaction, and size reduction processes. These granules are suitable for use in a variety of applications. Food products sweetened with granulated N-[N-(3,3-dimethylbutyl)-L-α-aspartyl]-L-phenylalanine 1-methyl ester and methods of sweetening food products with such N-[N-(3,3-dimethylbutyl)-L-α-aspartyl]-L-phenylalanine 1-methyl ester are also disclosed.

This application claims the benefit of U.S. Provisional Patent Application No. 60/182,908, filed Feb. 16, 2000.

### BACKGROUND OF THE INVENTION

1. Field of the Invention

This invention relates to the formation of granules of N-[N-(3,3-dimethylbutyl)-L-α-aspartyl]-L-phenylalanine 1-methyl ester (neotame) by compaction and size reduction. Neotame is converted from a light powder to relatively dustless, free-flowing granules suitable for use in a variety of applications. This invention also relates to food products sweetened with the neotame granules, as well as to methods of preparing such food products.

2. Related Background Art

It is known that N-[N-(3,3-dimethylbutyl)-L-α-aspartyl]-phenylalanine 1-methyl ester (neotame) is an extremely potent sweetening agent (about 8000× sweeter than sugar) that has the formula

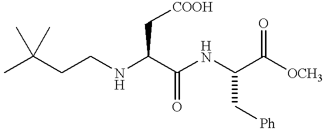

Clearly, the use of a high potency sweetener such as N-[N-(3,3-dimethylbutyl)-L-α-aspartyl]-L-phenylalanine 1-methyl ester requires consideration of the ability to deliver the sweetener in a given application. Thus, effective means for delivering neotame in desired compositions are very useful.

Pressure agglomeration techniques are employed in a variety of industries, including the pharmaceutical, agricultural and mining industries. These techniques are employed primarily as size enlargement processes. Wolfgang Pietsch, Size Enlargement by Agglomeration, John Wiley & Sons, pp. 218-221 (1991). Examples of such pressure agglomeration techniques include roller compaction, tableting, slugging, ram extrusion, plunger pressing, roller briquetting, reciprocating piston processing, die pressing and pelleting.

Roller compaction is a pressure agglomeration technique, well known and used in the pharmaceutical industry to provide materials with better content uniformity and handling properties. Ronald W. Miller, “Roller Compaction Technology”, Handbook of Pharmaceutical Granulation Techniques, Marcel Dekker, Inc., pp. 99-150 (1997). Typically, roller compaction is used in conjunction with an appropriate size reduction process. Further, roller compaction and optional size reduction is known in the food ingredient, chemical and plastic industries as well.

In compaction granulation, typically a granulation process is utilized which first coarsely breaks the compacted material into larger than desired particles. These particles are then milled until they pass through a screen or perforated plate which has either a slightly larger or almost the same size opening as the upper limit of the desired particle size range. This material is then sieved using almost the same size opening as the lower limit of the desired particle size. The granules that remain on the sieve are collected as final product. The finer fraction is recycled for compaction.

The granulation of α-L-aspartyl-L-phenylalanine or aspartame is known in the sweetener industry. U.S. Pat. No. 5,473,097 describes aspartame having improved solubility characteristics, obtained by granulating the aspartame to a grain size of 100-1400 μm. The '097 patent discloses that such granulation can be accomplished by any known method of mixing granulation, including powder compression granulation.

U.S. Pat. No. 5,358,186 describes a process for the reduction or prevention of the formation of fine, powdery dipeptide sweeteners, in particular, aspartame. According to the method of the '186 patent, aspartame is compacted, broken down, passed through a special screen or perforated plate having pore diameters from 1-10 mm, then further broken down and classified into various particle sizes.

It is important to note that certain particle sizes of a given material may be more useful for certain applications. For example, U.S. Pat. No. 5,834,018 discloses that aspartame particles having a very narrow particle size distribution, in which 97 wt. % of the particles are larger than 20-40 μm and 97 wt. % of the particles are smaller than 250-205 μm, are particularly suitable for use in tablets, powders and chewing gums. This is due to the granules' high dissolution rate, good flow properties, good dispersibility, little dust formation and virtual absence of electrostatic charging.

Granules of N-[N-(3,3-dimethylbutyl)-L-α-aspartyl]-L-phenylalanine 1-methyl ester formed by compaction and size reduction are not disclosed or suggested by the aforementioned art.

### SUMMARY OF THE INVENTION

The present invention is directed to a process for forming granules of N-[N-(3,3-dimethylbutyl)-L-α-aspartyl]-L-phenylalanine 1-methyl ester. This process comprises the steps of (a) compacting N-[N-(3,3-dimethylbutyl)-L-α-aspartyl]-L-phenylalanine 1-methyl ester powder to form compacts; (b) breaking up said compacts to form granules; and, optionally, (c) screening said granules to obtain granules of N-[N-(3,3-dimethylbutyl)-L-α-aspartyl]-L-phenylalanine 1-methyl ester having a desired particle size.

In a preferred embodiment of the present invention, the compacting step is accomplished using roller compaction; the compacts take the form of flakes or chips. In further preferred embodiments of the present invention, the breaking up step is accomplished using a mill.

This invention is further directed to granules of N-[N-(3,3-dimethylbutyl)-L-α-aspartyl]-L-phenylalanine 1-methyl ester made according to the process of the present invention.

Additional embodiments of the present invention are directed to food products sweetened with such granules of neotame and to methods of sweetening food products with the granules of neotame of this invention.

### DETAILED DESCRIPTION

Generally, N-[N-(3,3-dimethylbutyl)-L-α-aspartyl]-L-phenylalanine 1-methyl ester (neotame) exists as a light, somewhat dusty powder. It is important to note that neotame powder is not very easy to use or handle due to its dusting tendencies and poor flowability properties. The extreme potency of neotame exacerbates the problems associated with dusting, e.g., loss of material, dust contamination of other products, and human irritability with respect to the highly potent neotame dust. Neotame's extreme potency also presents unique problems with respect to delivery including the manipulation of very small amounts of neotame and the preservation of homogeneity. Thus, it is desirable to granulate neotame to reduce dusting and thereby minimize loss, to improve flowability and to provide an acceptable delivery form.

Neotame granulation may be accomplished using any known wet or dry granulation processes like spray granulation using a wet binder with or without fluidization, powder compaction, pulverizing, extrusion, tumble agglomeration, etc. However, dry granulation such as powder compaction is most attractive due to its simplicity.

Compaction, preferably roller compaction, with size reduction can be used as a particle formation technique to form relatively dustless, free flowing granules of N-[N-(3,3-dimethylbutyl)-L-α-aspartyl]-L-phenylalanine 1-methyl ester. As used herein, the term “granules” refers to free-flowing, relatively non-dusty, mechanically strong particles of N-[N-(3,3-dimethylbutyl)-L-α-aspartyl]-L-phenylalanine 1-methyl ester.

The granules of the present invention have better handling properties and flowability than neotame powder. Typically, the granules of the present invention have a higher bulk density than neotame powder. Compaction of neotame also helps to eliminate the loss of this valuable and potent material through dust. The granulation process of the present invention comprises compaction, preferably roller compaction, followed by size reduction and optional size classification to obtain the desired particle size range.

In particular, neotame is first compacted into compacts and then milled and classified to remove “overs” and “fines” to obtain neotame granules of the desired particle size range. As used herein, the term “overs” refers to material larger than the largest particle size desired, and the term “fines” refers to material smaller than the smallest particle size desired. Overs are typically milled again to obtain desired particle sizes, and fines are typically recycled and recompacted.

Hence, one embodiment of the present invention is directed to a process by which granules of neotame are formed using compaction.

In the first step of this process, neotame powder is compacted into compacts.

Compaction can be accomplished using any known compaction technique. Suitable techniques include, without limitation, roller compaction, tableting, slugging, ram extrusion, plunger pressing, roller briquetting, reciprocating piston processing, die pressing and pelleting. Because neotame has a low melting point (˜82° C.) as compared to other artificial sweeteners, it may be desirable to reduce the possibility of heat generation by employing a cooling means during compaction. For example, roller compactors are currently available which are equipped with means for cooling the rollers.

The compacts may take any form that can be subjected to subsequent size reduction. Suitable forms include, without limitation, flakes, chips, briquets, chunks, and pellets. The shape and appearance of the compacts vary depending upon the shape and surface characteristics of the equipment used to perform the compacting step. Accordingly, the compacts may appear smooth, corrugated, fluted or pillow-pocketed. The actual size and characteristics of the compacts depend upon the type of equipment and operation parameters employed during compaction.

Any powdered form of neotame may be used in the compositions of this invention. U.S. Pat. No. 5,480,668, U.S. Pat. No. 5,510,508 and U.S. Pat. No. 5,728,862, which describe the preparation of neotame are incorporated by reference herein. Further, salts and metal complexes of neotame may be used, such as disclosed in U.S. patent application Ser. No. 09/146,963, U.S. patent application Ser. No. 09/146,964, U.S. patent application Ser. No. 09/148,134, and U.S. patent application Ser. No. 09/146,965, all filed Sep. 4, 1998, and all of which are incorporated by reference herein. The anhydrous form of neotame is suitable for use in this invention, as well as the various crystalline forms of neotame. Other exemplary forms of neotame that may be useful in this invention include cyclodextrin/neotame complexes such as disclosed in U.S. Provisional Patent Application No. 60/100,867 and co-crystallized neotame disclosed in U.S. patent application Ser. No. 09/154,568, both filed Sep. 17, 1998, the disclosure of both of which are incorporated by reference herein.

Neotame may be present in a compact or granule of the present invention in any amount from 0.01% to 100% by weight. Clearly, the amount of neotame depends on a variety of factors including the presence and identity of other compact or granule components and the desired end use for the resultant granule.

It is possible, and, in fact, it is desirable to deaerate the neotame powder prior to compaction. Such deaeration leads to more effective compaction and the formation of stronger compacts and resultant granules. Deaeration may be accomplished through any known means, including, without limitation, screw feeding, vacuum deaeration and combinations thereof.

Optionally, a dry binder may be mixed with the neotame powder prior to compaction. Ultimately, the use of a dry binder improves the strength of the granules and also aids in their dispersion in liquids. P. J. Sheskey, “Evaluation of Various Polymers as Dry Binders in the Preparation of an Immediate-Release Tablet Formulation by Roller Compaction”, Pharm. Tech., vol. 19, pp. 98-112 (1995). Suitable dry binders include, without limitation, pregelatinized corn starch, microcrystalline cellulose, hydrophilic polymers (such as methyl cellulose, hydroxypropylmethyl cellulose, hydroxypropyl cellulose, polyvinylpyrrolidone, alginates, xanthan gum, gellan gum, and gum arabic) and mixtures thereof. Preferably, the binder is hydroxypropylmethyl cellulose.

The dry binder is generally used in amount from about 0.1% to about 40% by weight of the neotame powder. Preferably, the dry binder is used in an amount from about 1% to about 20% by weight of the neotame powder.

In a preferred embodiment of this invention, neotame powder is compacted into flakes or chips using a roller compactor.

Typically, as described in “Roller Compaction Technology” by Ronald W. Miller, Handbook of Pharmaceutical Granulation Technology, Marcel Dekker, Inc., pp. 99-150 (1997), compaction of a powder (with or without dry binder) is accomplished using a conventional roller compaction apparatus. Such an apparatus usually consists of a hopper for feeding the powder to be compacted and a pair of counter-rotating rolls. The powder may be fed to the apparatus through the hopper by gravity or by a force-feed screw. Either or both rolls are fixed onto their axes, with one roll optionally slightly moveable.

According to the present invention, neotame is fed into the hopper and is drawn into the nip angle area. The neotame is then drawn near the roll pair and is predensified. Then the neotame is drawn into the roll gap, and there it is compacted and plastic deformation occurs. Long, thick flakes or chips of neotame are obtained as a result of this processing. The actual size of the compacts depends upon the width of the roll and the scale of the equipment employed. The characteristics of the compacts, such as hardness, density and thickness, depend on factors including pressure, roll speed, feed rate and feed screw amps employed during the compaction process.

In the second step of the process of the present invention, the neotame compacts are broken up to form granules. This can be accomplished by any known means, including a mill. The breaking up step may be accomplished in a single step or it may preferably be accomplished through a series of steps, using a variety of opening sizes for the mill. In this way, the amount of fines produced may be reduced. Typically, granulation or breaking up is accomplished in two steps, namely, a course breaking step and a subsequent milling step.

As a result of this second step, neotame granules of varying size are obtained. A final and optional step in the process of the present invention is screening the granules to obtain granules of a desired particle size range. This step can be accomplished by any conventional means for screening particles, including screeners and sifters.

Another optional step in the method of the present invention is a recycling step. According to the recycling step of the present method, the neotame fines resulting from the size reduction step are recycled back to the compactor feed.

The neotame granules of this invention typically have a particle size ranging from about 20 to about 200 mesh. Preferably, the granules have a particle size ranging from about 20 to about 60 mesh, from about 60 to about 100 mesh, from about 100 to about 200 mesh, or through 200 mesh. The particle size range varies depending on the device used in the second step of the present process.

Importantly, certain size granules of the present invention may be particularly suitable for use in certain applications, given the improved properties of the inventive granules over the neotame powder (i.e., bulk density, flowability and dissolution). For example, granules ranging from 20 to 60 mesh or 60 to 100 mesh may be particularly suitable for use in fruit preparations and liquid beverages (i.e., liquid applications). Additionally, particles ranging from 100 to 200 mesh may be particularly suitable for use in powdered soft drinks, dry dessert mixes, ice creams and yogurts. Further, granules having a particle size through 200 mesh may be particularly suitable for use in dry mixes, refrigerated and frozen products and chewable tablets and may be particularly suited for encapsulation for use in confections and baked goods.

The granules of neotame of the present invention are suitable for use in any food composition to supplement or replace natural sweeteners, as well as other high intensity sweeteners, normally used as sweeteners. The term food as used herein includes, for example, beverages, fluid dairy products, condiments, baked goods, frostings, bakery fillings, cereals, nutraceuticals, gelatins, candy and chewing gum. In that regard, the disclosures of copending U.S. patent application Ser. Nos. 09/213,263, 09/213,860 and 09/215,460, all filed Dec. 17, 1998, directed to the use of neotame in dairy products, baked goods and beverages, respectively, are incorporated by reference herein. Further, the disclosures of copending U.S. patent application Ser. No. 09/465,402, filed Dec. 17, 1999, and copending U.S. Provisional Patent Application Nos. 60/125,617, filed Mar. 22, 1999, 60/126,191, filed Mar. 25, 1999, and 60/126,654, filed Mar. 29, 1999, directed to the use of neotame in chewing gum, cereals, gelatins and nutraceuticals, respectively, are incorporated by reference herein. The neotame granules of the present invention are also suitable for use in any table-top composition. In that regard, the disclosure of copending U.S. patent application Ser. No. 09/215,461, filed Dec. 17, 1998, directed to the use of neotame in table-top compositions is incorporated by reference herein.

This invention is also directed to food or table-top compositions, such as described above, containing an effective amount of the neotame granules of the present invention to sweeten the food or table-top composition. Determination of the amount of neotame granules to be added to the food or table-top composition can be readily determined by one of ordinary skill in the art.

The granules of neotame of the present invention can be used for these purposes alone or in combination with known bulking agents. Such bulking agents can be mixed with neotame powder prior to compaction or mixed with the final neotame granules of the present invention. Such a bulking agent is generally used in an amount from about 25% to about 99.99% by weight of the neotame powder, and preferably from about 50% to about 99.99% by weight of the neotame powder. Suitable bulking agents include, but are not limited to, dextrose, maltodextrin, lactose, inulin, polyols, polydextrose, cellulose and cellulose derivatives and organic acids including, but not limited to, citric acid and malic acid. Such a product may be suitable for use especially for table-top sweeteners, tablet granulations and powdered soft drinks.

The neotame granules of this invention may be used in combination with known natural sweeteners as well as other high intensity sweeteners. Such sweeteners can be mixed with neotame powder prior to compaction or mixed with the final neotame granules of the present invention. Such a sweetener is generally used in an amount from about 0.01% to about 99.99% by weight of the neotame powder, and preferably from about 1% to about 99% by weight of the neotame powder. Sweeteners that may be employed include, without limitation, aspartame, acesulfame salts (e.g., acesulfame-K), sucralose, saccharin, alitame, cyclamates, stevia derivatives, thaumatin, sucrose (liquid and granulated), high fructose corn syrup, high conversion corn syrup, crystalline fructose, glucose (dextrose), polyol sugar alcohols, invert sugar and mixtures thereof.

The neotame granules of this invention may be used in combination with known taste-modifying additives such as those disclosed in U.S. Provisional Patent Application Nos. 60/134,058 or 60/134,064, both filed May 13, 1999, the disclosures of both of which are incorporated by reference herein. Such taste-modifying additives can be mixed with neotame powder prior to compaction or mixed with the final neotame granules of the present invention.

The neotame granules of the present invention are particularly suitable for use in table-top compositions and powdered soft drink mixes. Hence, certain embodiments of the present invention are directed to methods for preparing these. Table-top sweeteners and powdered soft drink mixes can be made according to the present invention by forming a premix of a sweetening effective amount of neotame, a binding agent and a carrier, compacting the premix to form compacts; and breaking up the compacts to form granules. In these embodiments, the binding agent includes, without limitation, maltodextrin, dextrose-maltodextrin blends, hydroxypropylmethyl cellulose, carboxymethyl cellulose, polyvinylpyrrolidone, sucrose and mixtures thereof. Likewise, the carrier includes, without limitation, dextrose, citric acid, maltodextrin, dextrose-maltodextrin blends, lactose, inulin, erythritol, sorbitol, sucrose, aspartame, acesulfame salts, sucralose, cyclamate, saccharin, stevioside, alitame and mixtures thereof. Both the binding agent and the carrier may be the same.

A table-top sweetener comprising the present granules of neotame may also include any other ingredients commonly present in table-top sweeteners in order to tailor the taste of the product to a specific end use. A table-top sweetener comprising the present granules of neotame may take any known form. Suitable forms include, but are not limited to, sachets including the sweetener in powder or granular form, tablets, liquid sweeteners, and jar, pouches, pocket or other forms in which the sweetener may be measured in, for example, spoon for spoon form.

An additional embodiment of the present invention is directed to a process for preparing a blend of neotame granules and a blending agent by forming neotame granules as described in detail above and then dry blending the granules with a blending agent. In this embodiment, the blending agent includes, without limitation, aspartame, acesulfame salts, sucralose, saccharin, alitame, cyclamates, stevia derivatives, thaumatin, sucrose, fructose, dextrose, polyol sugar alcohols, dextrose, citric acid, dextrin, maltodextrin, dextrose-maltodextrin blends, lactose, inulin, erythritol, sorbitol, stevioside, hydroxypropylmethyl cellulose, carboxymethyl cellulose, polyvinylpyrrolidone, N-[N-(3,3-dimethylbutyl)-L-α-aspartyl]-L-phenylalanine 1-methyl ester and mixtures thereof.

The Examples which follow are intended as an illustration of certain preferred embodiments of the invention, and no limitation of the invention is implied.

### EXAMPLE 1

Four samples of neotame were granulated using the following roller compaction method. Roller compaction was effected for each of the samples using a lab scale TF-Mini roller compactor (Vector Corp., Marion, Iowa) according to the parameters given in Table 1.

TABLE 1
Roller Compaction Parameters.

| | roll | feed | roll |
|---|---|---|---|
| | speed | speed | pressure |
| sample | (rpm) | (rpm) | (kg/cm²) |
| 1 | 5 | 25 | 80 |
| 2 | 6 | 25 | 80 |
| 3 | 6 | 25 | 90 |
| 4 | 5 | 25 | 70 |

Long flakes (6-7″) were obtained which discharged in between the rolls vertically without sticking to the roll surfaces. The roller compaction process lasted about 5 minutes for each sample. Long flakes of neotame were obtained. The flakes were analyzed for thickness, density (loose and packed), moisture, melting point and hardness. The results are shown in Table 2.

Hardness was determined using a ball and pan hardness test as described below. Approximately 75 g of the neotame to be tested was screened on an 80 mesh screen and shaken with a Ro-Tap testing sieve shaker (model B, CE Tyler Combustion Engineering, Inc., Mentor, Ohio) for ten minutes with a hammer. About 50 g +/−1 g of the neotame retained on the 80 mesh screen was transferred to the pan of the screen assembly. Ten 0.5″ steel balls were placed in the pan, and a new 80 mesh screen was positioned above the pan. The Ro-Tap shaker was run for another ten minutes without the hammer. The assembly was removed from the Ro-Tap shaker, and the steel balls were removed from the pan. The neotame from the pan was then transferred to the 80 mesh screen, and the screen and pan were reassembled. The neotame and screen were then placed in the Ro-Tap shaker for ten minutes with the hammer. The fraction of neotame retained on the 80 mesh screen was weighed. Hardness was calculated according to the formula: % hardness=(weight retained on 80 mesh/total weight of sample)×100.

TABLE 2
Flake Characteristics.

| sample | 1 | 2 | 3 | 4 |
|---|---|---|---|---|
| flake | 2.27 | 1.85 | 1.77 | 2.19 |
| thickness | | | | |
| (mm) | | | | |
| density - | 0.56 | 0.57 | 0.58 | |
| loose | | | | |
| (g/cc) | | | | |
| density - | 0.65 | 0.65 | 0.67 | |
| packed | | | | |
| (g/cc) | | | | |
| moisture | 4.48 | 4.47 | 4.55 | 4.24 |
| (%) | | | | |
| melting | 77.2/83.5 | 77.5/83.6 | 76.8/83.5 | 77.6/83.5 |
| point | | | | |
| (° C.) | | | | |
| hardness | 92.80 | 91.00 | 93.40 | 92.20 |
| (%) | | | | |

Then the flakes were fed into a cone mill (model 197-S, Quadro Engineering Inc., Ontario, Canada) with 10 mesh conical sieve with a half inch hole in the bottom center at speed 10 (maximum) for size reduction and classification. The results of the granule formation and classification are shown in Table 3.

TABLE 3
Percent Retained.

| sample | 1 | 2 | 3 | 4 |
|---|---|---|---|---|
| 14 mesh | 9.2 | 3.2 | 0 | 8.8 |
| 20 mesh | 24.5 | 22.3 | 28.1 | 22.4 |
| 40 mesh | 20.6 | 26.3 | 27.6 | 26.3 |
| 60 mesh | 11.5 | 12.5 | 11 | 12.9 |
| 100 mesh | 9.6 | 10.6 | 7.9 | 9.8 |
| 200 mesh | 18.2 | 21.1 | 17.3 | 13.2 |
| pan | 4.4 | 3.9 | 4.1 | 4.6 |

### EXAMPLE 2

A lab scale TF-Mini roller compactor (Vector Corp., Marion, Iowa) was used in conjunction with a cone mill and a Ro-Tap testing sieve shaker (model B, CE Tyler Combustion Engineering, Inc., Mentor, Ohio) for testing and producing granulated neotame. The neotame powder flowed well into the feed hopper. The compacted flakes were strong and had a “fused” appearance. The compactor did not make any significant crackling noises, indicating very efficient compaction without much air entrapment. The energy consumption of the rolls and feed screw were within the desired limits. The flakes were broken down into granular particles using a cone mill. The granulation was sieved to obtain a particle size that passed through 20 mesh and was retained on 60 mesh. This granulation was non-dusty, had a bulk density of 0.6 g/cc (initial powder was 0.4 g/cc) and very good flow properties. HPLC analysis showed that there was no degradation of neotame during this granulation process.

Physical Properties of Roller Compacted Neotame Granules

Roller compacted neotame obtained from Examples 1 and 2 was divided into various particle size ranges using an Alpine Air Jet Sifter (model A200LS, Hosokawa Micron Powder Systems, Summit, N.J.). The particle size ranges were: 20-60 mesh, 60-100 mesh, 100-200 mesh and through 200 mesh. These samples were tested for bulk density, flowability and dissolution rate. The results are shown in Table 4.

In particular, bulk density (loose) was measured using a cup of known volume. The cup was filled with sample, excess was removed and the sample was weighed.

The flowability of each sample was measured using a stainless steel funnel (orifice diameter 0.270″). The time taken for the sample to flow out through the orifice of the funnel was measured using a stop watch.

The dissolution rate of each sample was measured as a function of absorbance at 258 nm using a spectrophotometer. Sample (0.015 g) was added to 150 g deionized water at 20° C. The water was continuously stirred, and absorbance was measured versus time until it reached its highest value and became constant. The time required to reach the highest level of absorbance has been reported as “dissolution rate”.

TABLE 4
Characteristics of Roller Compacted Neotame

| | bulk density | | |
|---|---|---|---|
| | (loose) | flowability | dissolution |
| sample | (g/cc) | (g/sec) | rate (min) |
| 20-60 mesh | 0.59 | 3.30 | 16 |
| 60-100 mesh | 0.55 | 4.50 | 3 |
| 100-200 mesh | 0.51 | 4.65 | 1.5 |
| through 200 | 0.39 | no flow | 1 |
| mesh | | | |

The above data shows that the physical properties (bulk density, flowability, dissolution) of neotame granules can be modified by using different particle size ranges. This can help in creating value-added neotame granular forms tailored for specific applications, based on the requirements of the application.

Other variations and modifications of this invention will be obvious to those skilled in this art. This invention is not to be limited except as set forth in the following claims.

What is claimed is:

1. A process for forming granules of N-[N-(3,3-dimethylbutyl)-L-α-aspartyl]-L-phenylalanine 1-methyl ester comprising the steps of:
(a) compacting N-[N-(3,3-dimethylbutyl)-L-α-aspartyl]-L-phenylalanine 1-methyl ester powder to form compacts; and
(b) breaking up said compacts to form said granules of N-[N-(3,3-dimethylbutyl)-L-α-aspartyl]-L-phenylalanine 1-methyl ester.

2. The process according to claim 1, further comprising the step of screening said granules of N-[N-(3,3-dimethylbutyl)-L-α-aspartyl]-L-phenylalanine 1-methyl ester to obtain a desired particle size.

3. The process according to claim 1, wherein a dry binder is mixed with the N-[N-(3,3-dimethylbutyl)-L-α-aspartyl]-L-phenylalanine 1-methyl ester before the compacting step.

4. The process according to claim 3, wherein said dry binder is selected from the group consisting of pregelatinized corn starch, microcrystalline cellulose, hydrophilic polymers and mixtures thereof.

5. The process according to claim 4, wherein said hydrophilic polymer is selected from the group consisting of methyl cellulose, hydroxypropylmethyl cellulose, hydroxypropyl cellulose, polyvinylpyrrolidone, alginates, xanthan gum, gellan gum, gum arabic and mixtures thereof.

6. The process according to claim 3, wherein said dry binder is used in an amount from about 0.1% to about 40% by weight of the neotame powder.

7. The process according to claim 6, wherein said dry binder is used in an amount from about 1% to about 20% by weight of the neotame powder.

8. The process according to claim 1, wherein a known natural sweetener or other high intensity sweetener is mixed with the N-[N-(3,3-dimethylbutyl)-L-α-aspartyl]-L-phenylalanine 1-methyl ester before the compacting step.

9. The process according to claim 8, wherein said known natural sweetener or other high intensity sweetener is selected from the group consisting of aspartame, acesulfame salts, sucralose, saccharin, alitame, cyclamates, stevia derivatives, thaumatin, sucrose, high fructose corn syrup, high conversion corn syrup, crystalline fructose, glucose, dextrose, polyol sugar alcohols, invert sugar and mixtures thereof.

10. The process according to claim 8, wherein said known natural sweetener or other high intensity sweetener is used in an amount from about 0.01% to about 99.99% by weight of the neotame powder.

11. The process according to claim 10, wherein said known natural sweetener or other high intensity sweetener is used in an amount from about 1% to about 99% by weight of the neotame powder.

12. The process according to claim 1, wherein a bulking agent is mixed with the N-[N-(3,3-dimethylbutyl)-L-α-aspartyl]-L-phenylalanine 1-methyl ester before the compacting step.

13. The process according to claim 12, wherein said bulking agent is selected from the group consisting of dextrose, maltodextrin, lactose, inulin, polyols, polydextrose, cellulose, cellulose derivatives, organic acids and mixtures thereof.

14. The process according to claim 12, wherein said bulking agent is used in an amount from about 25% to about 99.99% by weight of the neotame powder.

15. The process according to claim 14, wherein said bulking agent is used in an amount from about 50% to about 99.99% by weight of the neotame powder.

16. The process according to claim 1, wherein said compacting step is accomplished using a method selected from the group consisting of roller compaction, tableting, slugging, ram extrusion, plunger pressing, roller briquetting, reciprocating piston processing, die pressing and pelleting.

17. The process according to claim 16, wherein said method is roller compaction using a roller compactor and wherein said compacts take the form of flakes or chips.

18. The process according to claim 1, wherein said breaking up step is accomplished using a mill.

19. A N-[N-(3,3-dimethylbutyl)-L-α-aspartyl]-L-phenylalanine 1-methyl ester composition made according to the process comprising the steps of:
(a) compacting N-[N-(3,3-dimethylbutyl)-L-α-aspartyl]-L-phenylalanine 1-methyl ester powder to form compacts; and
(b) breaking up said compacts to form granules of N-[N-(3,3-dimethylbutyl)-L-α-aspartyl]-L-phenylalanine 1-methyl ester.

20. The N-[N-(3,3-dimethylbutyl)-L-α-aspartyl]-L-phenylalanine 1-methyl ester composition according to claim 19, wherein said compacting is accomplished using roller compaction and wherein said compacts take the form of flakes or chips.

21. The N-[N-(3,3-dimethylbutyl)-L-α-aspartyl]-L-phenylalanine 1-methyl ester composition according to claim 19, wherein said granules of N-[N-(3,3-dimethylbutyl)-L-α-aspartyl]-L-phenylalanine 1-methyl ester have a particle size from about 20 mesh to about 200 mesh.

22. The N-[N-(3,3-dimethylbutyl)-L-α-aspartyl]-L-phenylalanine 1-methyl ester composition according to claim 21, wherein said granules of N-[N-(3,3-dimethylbutyl)-L-α-aspartyl]-L-phenylalanine 1-methyl ester have a particle size from about 20 mesh to about 60 mesh.

23. The N-[N-(3,3-dimethylbutyl)-L-α-aspartyl]-L-phenylalanine 1-methyl ester composition according to claim 21, wherein said granules of N-[N-(3,3-dimethylbutyl)-L-α-aspartyl]-L-phenylalanine 1-methyl ester have a particle size from about 60 mesh to about 100 mesh.

24. The N-[N-(3,3-dimethylbutyl)-L-α-aspartyl]-L-phenylalanine 1-methyl ester composition according to claim 21, wherein said granules of N-[N-(3,3-dimethylbutyl)-L-α-aspartyl]-L-phenylalanine 1-methyl ester have a particle size from about 100 mesh to about 200 mesh.

25. The N-[N-(3,3-dimethylbutyl)-L-α-aspartyl]-L-phenylalanine 1-methyl ester composition according to claim 21, wherein said granules of N-[N-(3,3-dimethylbutyl)-L-α-aspartyl]-L-phenylalanine 1-methyl ester have a particle size greater than about 200 mesh.

26. The N-[N-(3,3-dimethylbutyl)-L-α-aspartyl]-L-phenylalanine 1-methyl ester composition according to claim 19, wherein a dry binder is mixed with the N-[N-(3,3-dimethylbutyl)-L-α-aspartyl]-L-phenylalanine 1-methyl ester before the compacting step.

27. The N-[N-(3,3-dimethylbutyl)-L-α-aspartyl]-L-phenylalanine 1-methyl ester composition according to claim 26, wherein said dry binder is selected from the group consisting of pregelatinized corn starch, microcrystalline cellulose, hydrophilic polymers and mixtures thereof.

28. The N-[N-(3,3-dimethylbutyl)-L-α-aspartyl]-L-phenylalanine 1-methyl ester composition according to claim 27, wherein said hydrophilic polymer is selected from the group consisting of methyl cellulose, hydroxypropylmethyl cellulose, hydroxypropyl cellulose, polyvinylpyrrolidone, alginates, xanthan gum, gellan gum, gum arabic and mixtures thereof.

29. The N-[N-(3,3-dimethylbutyl)-L-α-aspartyl]-L-phenylalanine 1-methyl ester composition according to claim 26, wherein said dry binder is used in an amount from about 0.1% to about 40% by weight of the neotame powder.

30. The N-[N-(3,3-dimethylbutyl)-L-α-aspartyl]-L-phenylalanine 1-methyl ester composition according to claim 29, wherein said dry binder is used in an amount from about 1% to about 20% by weight of the neotame powder.

31. The N-[N-(3,3-dimethylbutyl)-L-α-aspartyl]-L-phenylalanine 1-methyl ester composition according to claim 19, wherein a known natural sweetener or other high intensity sweetener is mixed with the N-[N-(3,3-dimethylbutyl)-L-α-aspartyl]-L-phenylalanine 1-methyl ester before the compacting step.

32. The N-[N-(3,3-dimethylbutyl)-L-α-aspartyl]-L-phenylalanine 1-methyl ester composition according to claim 31, wherein said known natural sweetener or other high intensity sweetener is selected from the group consisting of aspartame, acesulfame salts, sucralose, saccharin, alitame, cyclamates, stevia derivatives, thaumatin, sucrose, high fructose corn syrup, high conversion corn syrup, crystalline fructose, glucose, dextrose, polyol sugar alcohols, invert sugar and mixtures thereof.

33. The N-[N-(3,3-dimethylbutyl)-L-α-aspartyl]-L-phenylalanine 1-methyl ester composition according to claim 31, wherein said known natural sweetener or other high intensity sweetener is used in an amount from about 0.01% to about 99.99% by weight of the neotame powder.

34. The N-[N-(3,3-dimethylbutyl)-L-α-aspartyl]-L-phenylalanine 1-methyl ester composition according to claim 33, wherein said known natural sweetener or other high intensity sweetener is used in an amount from about 1% to about 99% by weight of the neotame powder.

35. The N-[N-(3,3-dimethylbutyl)-L-α-aspartyl]-L-phenylalanine 1-methyl ester composition according to claim 19, wherein a bulking agent is mixed with the N-[N-(3,3-dimethylbutyl)-L-α-aspartyl]-L-phenylalanine 1-methyl ester before the compacting step.

36. The N-[N-(3,3-dimethylbutyl)-L-α-aspartyl]-L-phenylalanine 1-methyl ester composition according to claim 35, wherein said bulking agent is selected from the group consisting of dextrose, maltodextrin, lactose, inulin, polyols, polydextrose, cellulose, cellulose derivatives, organic acids and mixtures thereof.

37. The N-[N-(3,3-dimethylbutyl)-L-α-aspartyl]-L-phenylalanine 1-methyl ester composition according to claim 35, wherein said bulking agent is used in an amount from about 25% to about 99.99% by weight of the neotame powder.

38. The N-[N-(3,3-dimethylbutyl)-L-α-aspartyl]-L-phenylalanine 1-methyl ester composition according to claim 37, wherein said bulking agent is used in an amount from about 50% to about 99.99% by weight of the neotame powder.

39. A method of sweetening a food by including in said food a N-[N-(3,3-dimethylbutyl)-L-α-aspartyl]-L-phenylalanine 1-methyl ester composition according to claim 19 in an amount effective to sweeten said food.

40. The method according to claim 39, wherein said food is selected from the group consisting of beverages, fluid dairy products, condiments, baked goods, frostings, bakery fillings, candy and chewing gum.

41. A sweetened food comprising a N-[N-(3,3-dimethylbutyl)-L-α-aspartyl]-L-phenylalanine 1-methyl ester composition according to claim 19 in an amount effective to sweeten the food.

42. The sweetened food according to claim 41, wherein said food is selected from the group consisting of beverages, fluid dairy products, condiments, baked goods, frostings, bakery fillings, candy and chewing gum.

43. A method of preparing a table-top sweetener comprising the steps of:
(a) forming a premix of a sweetening effective amount of N-[N-(3,3-dimethylbutyl)-L-α-aspartyl]-L-phenylalanine 1-methyl ester powder, a binding agent and a carrier;
(b) compacting said premix to form compacts; and
(c) breaking up said compacts to form granules.

44. The method of preparing a table-top sweetener according to claim 43, wherein said binding agent is selected from the group consisting of maltodextrin, dextrose-maltodextrin blends, hydroxypropylmethyl cellulose, carboxymethyl cellulose, polyvinylpyrrolidone, sucrose and mixtures thereof.

45. The method of preparing a table-top sweetener according to claim 43, wherein said carrier is selected from the group consisting of dextrose, citric acid, maltodextrin, dextrose-maltodextrin blends, lactose, inulin, erythritol, sorbitol, sucrose, aspartame, acesulfame salts, sucralose, cyclamate, saccharin, stevioside, alitame and mixtures thereof.

46. A table-top sweetener made according to the process comprising the steps of:
(a) forming a premix of a sweetening effective amount of N-[N-(3,3-dimethylbutyl)-L-α-aspartyl]-L-phenylalanine 1-methyl ester powder, a binding agent and a carrier;
(b) compacting said premix to form compacts; and
(c) breaking up said compacts to form granules.

47. The table-top sweetener according to claim 46, wherein said binding agent is selected from the group consisting of maltodextrin, dextrose-maltodextrin blends, hydroxypropylmethyl cellulose, carboxymethyl cellulose, polyvinylpyrrolidone, sucrose and mixtures thereof.

48. The table-top sweetener according to claim 46, wherein said carrier is selected from the group consisting of dextrose, citric acid, maltodextrin, dextrose-maltodextrin blends, lactose, inulin, erythritol, sorbitol, sucrose, aspartame, acesulfame salts, sucralose, cyclamate, saccharin, stevioside, alitame and mixtures thereof.

49. A method of preparing a powdered soft drink mix comprising the steps of:
(a) forming a premix of a sweetening effective amount of N-[N-(3,3-dimethylbutyl)-L-α-aspartyl]-L-phenylalanine 1-methyl ester powder, a binding agent and a carrier;
(b) compacting said premix to form compacts; and
(c) breaking up said compacts to form granules.

50. The method of preparing a powdered soft drink mix according to claim 49, wherein said binding agent is selected from the group consisting of maltodextrin, dextrose-maltodextrin blends, hydroxypropylmethyl cellulose, carboxymethyl cellulose, polyvinylpyrrolidone, sucrose and mixtures thereof.

51. The method of preparing a powdered soft drink mix according to claim 49, wherein said carrier is selected from the group consisting of dextrose, citric acid, maltodextrin, dextrose-maltodextrin blends, lactose, inulin, erythritol, sorbitol, sucrose, aspartame, acesulfame salts, sucralose, cyclamate, saccharin, stevioside, alitame and mixtures thereof.

52. A powdered soft drink mix made according to the process comprising the steps of:
(a) forming a premix of a sweetening effective amount of N-[N-(3,3-dimethylbutyl)-L-α-aspartyl]-L-phenylalanine 1-methyl ester powder, a binding agent and a carrier;
(b) compacting said premix to form compacts; and
(c) breaking up said compacts to form granules.

53. The powdered soft drink mix according to claim 52, wherein said binding agent is selected from the group consisting of maltodextrin, dextrose-maltodextrin blends, hydroxypropylmethyl cellulose, carboxymethyl cellulose, polyvinylpyrrolidone, sucrose and mixtures thereof.

54. The powdered soft drink mix according to claim 52, wherein said carrier is selected from the group consisting of dextrose, citric acid, maltodextrin, dextrose-maltodextrin blends, lactose, inulin, erythritol, sorbitol, sucrose, aspartame, acesulfame salts, sucralose, cyclamate, saccharin, stevioside, alitame and mixtures thereof.

55. A process for preparing a blend of granules of N-[N-(3,3-dimethylbutyl)-L-α-aspartyl]-L-phenylalanine 1-methyl ester and a blending agent comprising the steps of:
(a) compacting N-[N-(3,3-dimethylbutyl)-L-α-aspartyl]-L-phenylalanine 1-methyl ester powder to form compacts;
(b) breaking up said compacts to form said granules of N-[N-(3,3-dimethylbutyl)-L-α-aspartyl]-L-phenylalanine 1-methyl ester; and
(c) dry blending said granules of N-[N-(3,3-dimethylbutyl)-L-α-aspartyl]-L-phenylalanine 1-methyl ester with said blending agent.

56. The process for preparing a blend of granules of N-[N-(3,3-dimethylbutyl)-L-α-aspartyl]-L-phenylalanine 1-methyl ester and a blending agent according to claim 55, wherein said blending agent is selected from the group consisting of aspartame, acesulfame salts, sucralose, saccharin, alitame, cyclamates, stevia derivatives, thaumatin, sucrose, fructose, dextrose, polyol sugar alcohols, dextrose, citric acid, dextrin, maltodextrin, dextrose-maltodextrin blends, lactose, inulin, erythritol, sorbitol, stevioside, hydroxypropylmethyl cellulose, carboxymethyl cellulose, polyvinylpyrrolidone, N-[N-(3,3-dimethylbutyl)-L-α-aspartyl]-L-phenylalanine 1-methyl ester and mixtures thereof.

57. A blend of granules of N-[N-(3,3-dimethylbutyl)-L-α-aspartyl]-L-phenylalanine 1-methyl ester and a blending agent made according to the process comprising the steps of:
(a) compacting N-[N-(3,3-dimethylbutyl)-L-α-aspartyl]-L-phenylalanine 1-methyl ester powder to form compacts;
(b) breaking up said compacts to form said granules of N-[N-(3,3-dimethylbutyl)-L-α-aspartyl]-L-phenylalanine 1-methyl ester; and
(c) dry blending said granules of N-[N-(3,3-dimethylbutyl)-L-α-aspartyl]-L-phenylalanine 1-methyl ester with said blending agent.

58. The blend of granules of N-[N-(3,3-dimethylbutyl)-L-α-aspartyl]-L-phenylalanine 1-methyl ester and a blending agent according to claim 57, wherein said blending agent is selected from the group consisting of aspartame, acesulfame salts, sucralose, saccharin, alitame, cyclamates, stevia derivatives, thaumatin, sucrose, fructose, dextrose, polyol sugar alcohols, dextrose, citric acid, dextrin, maltodextrin, dextrose-maltodextrin blends, lactose, inulin, erythritol, sorbitol, stevioside, hydroxypropylmethyl cellulose, carboxymethyl cellulose, polyvinylpyrrolidone, N-[N-(3,3-dimethylbutyl)-L-α-aspartyl]-L-phenylalanine 1-methyl ester and mixtures thereof.
